(19) United States
(12) Patent Application Publication
(10) Pub. No.: US 2025/0309342 A1
(43) Pub. Date: Oct. 2, 2025

(54) ALL-SOLID-STATE BATTERY AND BATTERY MODULE

(71) Applicant: HONDA MOTOR CO., LTD., Tokyo (JP)

(72) Inventors: Nednapa PAGORNSIRIKUL, Saitama (JP); Masahiro HOKAZONO, Saitama (JP); Tomohiko TSUZAKI, Saitama (JP)

(21) Appl. No.: 19/063,791

(22) Filed: Feb. 26, 2025

(30) Foreign Application Priority Data
Mar. 29, 2024 (JP) 2024-057877

(51) Int. Cl. H01M 10/0562; H01M 10/0585

(52) U.S. Cl. CPC H01M 10/0562; H01M 10/0585

(57) ABSTRACT

An all-solid-state battery with less pressure variations has a plurality of electrode laminates each including a positive electrode layer, a negative electrode layer, and a solid electrolyte layer arranged between the positive electrode layer and the negative electrode layer; and at least one elastic sheet arranged between the electrode laminates, wherein some of the electrode laminates are in direct contact with adjacent one of the electrode laminates, and the at least one elastic sheet has a Young's modulus of 30 MPa or less.

This application is based on and claims the benefit of priority from Japanese Patent Application No. 2024-057877, filed on 29 Mar. 2024, the content of which is incorporated herein by reference.

### BACKGROUND OF THE INVENTION

### Field of the Invention

The present invention relates to an all-solid-state battery and a battery module.

### Related Art

Research and development of secondary batteries that contributes to improvement of energy efficiency is underway for more people to have access to reasonable, reliable, sustainable, and advanced energy. A promising one of the secondary batteries is an all-solid-state battery made by stacking electrode laminates each including a positive electrode, a solid electrolyte, and a negative electrode.

For prevention of problems such as performance deterioration and short circuits caused by metal deposition to the electrode, an all-solid-state battery in a widely adopted configuration includes two or more secondary batteries stacked in a thickness direction of the electrode, and the stack forming the all-solid-state battery is pressurized (bound) to reduce local deposition and other problems (see, e.g., Patent Document 1).

Patent Document 1: Japanese Unexamined Patent Application, Publication No. 2022-67647

### SUMMARY OF THE INVENTION

With regard to technology related to all-solid-state batteries, it is desirable for the all-solid-state batteries to be pressurized with a uniform pressure. Patent Document 1 describes a technique of absorbing the change in thickness of the electrode by placing elastic pads that are compressible in the thickness direction between the electrode laminates. However, if the all-solid-state battery is made of multiple thin electrode laminates, the pads absorbing the change in the electrode thickness increase the total thickness of the battery, which is non-negligible. Thus, it is desired to keep the all-solid-state battery from becoming thicker while reducing the variations in pressure exerted on the all-solid-state battery.

In view of the above circumstances, the present invention has been achieved to provide an all-solid-state battery and a battery module that can reduce the increase in thickness and can reduce the variations in pressure exerted on the electrode laminates, contributing to improvement in energy efficiency.

A first aspect of the present invention is directed to an all-solid-state battery including: a plurality of electrode laminates each having a positive electrode layer, a negative electrode layer, and a solid electrolyte layer arranged between the positive electrode layer and the negative electrode layer; and at least one elastic sheet arranged between the electrode laminates, wherein some of the electrode laminates are in direct contact with adjacent one of the electrode laminates, and the at least one elastic sheet has a Young's modulus of 30 MPa or less.

The all-solid-state battery of the first aspect uses a small number of elastic sheets having a relatively small Young's modulus, reducing the increase in thickness and the variations in pressure exerted on all the electrode laminates. According to a second aspect, in the all-solid-state battery of the first aspect, the number of the at least one elastic sheet is two or more and less than half the number of the electrode laminates.

The all-solid-state battery of the second aspect can sufficiently reduce the variations in pressure exerted on the electrode laminates, and can notably reduce the thickness of the whole all-solid-state battery.

According to the third aspect, in the all-solid-state battery of the first or second aspect, the at least one elastic sheet has a Young's modulus of 15 MPa or more and 20 MPa or less.

The all-solid-state battery of the third aspect can more reliably reduce the variations in pressure exerted on the electrode laminates.

A fourth aspect of the present invention is directed to a battery module, including: a plurality of the all-solid-state batteries of any one of the first to third aspects; and a pressurizing mechanism that applies a pressure binding the all-solid-state batteries in a thickness direction. The pressurizing mechanism applies a binding pressure of 3.0 MPa or less.

The battery module of the fourth aspect can optimize the pressure exerted on the electrode laminates, reducing performance deterioration of the all-solid-state battery due to local deposition of metal or any other substances.

According to a fifth aspect, in the battery module of the fourth aspect, the binding pressure applied by the pressurizing mechanism is 0.5 MPa or more and 2.0 MPa or less.

The battery module of the fifth aspect can more reliably reduce the performance deterioration of the all-solid-state battery.

The present invention can provide an all-solid-state battery and a battery module that reduce the increase in thickness and the variations in pressure exerted on electrode laminates.

### BRIEF DESCRIPTION OF THE DRAWINGS

FIG. 1 is a perspective view illustrating an all-solid-state battery according to an embodiment of the present invention.

FIG. 2 is a schematic sectional view illustrating the structure of the all-solid-state battery shown in FIG. 1.

FIG. 3 is a schematic plan view illustrating the structure of a battery module including the all-solid-state batteries shown in FIG. 1.

FIG. 4 is a graph of pressure variations measured when an elastic sheet having a Young's modulus of 18.5 MPa is used and a binding pressure is 1.0 MPa.

FIG. 5 is a graph of pressure variations measured when an elastic sheet having a Young's modulus of 18.5 MPa is used a binding pressure is 3.0 MPa.

FIG. 6 is a graph of pressure variations measured when an elastic sheet having a Young's modulus of 29.4 MPa is used and a binding pressure is 1.0 MPa.

FIG. 7 is a graph of pressure variations measured when an elastic sheet having a Young's modulus of 29.4 MPa is used and a binding pressure is 3.0 MPa.

### DETAILED DESCRIPTION OF THE INVENTION

Embodiments of the present invention will be described below with reference to the drawings. The following embodiments merely exemplify the present invention and do not limit the invention.

### All-Solid-State Battery

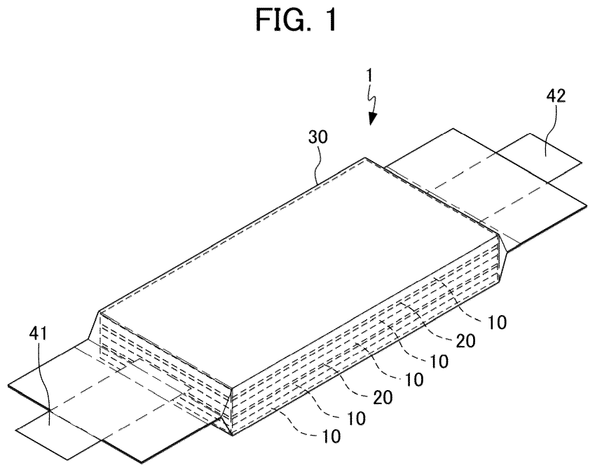

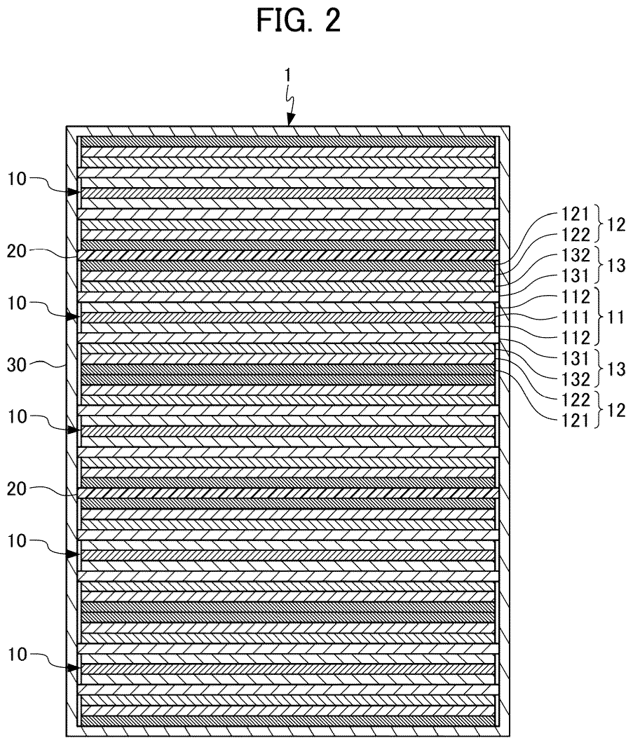

FIG. 1 is a perspective view illustrating an all-solid-state battery (all-solid-state battery cell) 1 according to an embodiment of the present invention. FIG. 2 is a schematic sectional view illustrating the structure of the all-solid- state battery 1. In FIG. 1, components are exaggerated for ease of understanding. Although FIG. 2 particularly shows the thickness of the components to be larger than in reality, their actual thicknesses are much small relative to their planar dimensions.

The all-solid-state battery 1 includes a plurality of electrode laminates 10, elastic sheets 20 arranged between the electrode laminates 10, an exterior body 30 that houses the electrode laminates 10 and the elastic sheets 20, and a positive electrode tab 41 and a negative electrode tab 42 that extend outward of the exterior body 30 from the electrode laminates 10.

The all-solid-state battery 1 preferably includes three to ten electrode laminates 10, more preferably four to seven electrode laminates 10. If the all-solid-state battery 1 includes more electrode laminates 10, the battery can output a higher current, but too many electrode laminates 10 thicken the all-solid-state battery 1 too much. In the all-solid-state battery 1, at least some of the electrode laminates 10 are in direct contact with adjacent one of the electrode laminates 10 without any elastic sheet 20. There are five electrode laminates in the illustrated embodiment, and the elastic sheets 20 are present between the first and second electrode laminates 10 from the top and between the third and fourth electrode laminates 10 from the top. The second electrode laminate 10 is in direct contact with the third electrode laminate 10, and the fourth electrode laminate 10 is also in direct contact with the fifth electrode laminate 10.

Each electrode laminate 10 includes a single positive electrode layer 1, two negative electrode layers 12 facing each other across the positive electrode layer 11, and two solid electrolyte layers 13 each of which is arranged between the positive electrode layer 11 and one of the negative electrode layers 12.

The positive electrode layer 11 includes a positive electrode current collector 111 and two positive electrode active material layers 112 stacked on both surfaces of the positive electrode current collector 111. The positive electrode current collector 111 is connected to the positive electrode tab 41.

The positive electrode current collector 111 may have any shape and may be made of any material as long as it exhibits the current collecting function of the positive electrode layer 11. Materials for the positive electrode current collector 111 may include, for example, aluminum, an aluminum alloy, stainless steel, nickel, iron, and titanium. Among them, aluminum, an aluminum alloy, and stainless steel are preferable. The positive electrode current collector 111 may be in the shape of, for example, foil, a plate, mesh, nonwoven fabric, or a foam.

The positive electrode active material layers 112 contain at least one positive electrode active material. Any positive electrode active material may be contained, and materials used for the positive electrode layers of general all-solid-state batteries can be used. Examples of the positive electrode active material include layered active materials, spinel-type active materials, and olivine-type active materials that contain lithium. Specific examples of the positive electrode active material include lithium cobalt oxide (LiCoO₂), lithium nickelate (LiNiO₂), LiNiₚMn_{q}CoᵣO₂ (p+q +r=1), LiNiₚAl_{q}CoᵣO₂ (p+q+r=1), lithium manganese (LiMn₂O₄), and heteroelement-substituted spinel-type lithium manganese represented by Li₁₊ₓMn_{2-x-y}MO₄ (x+y=2, M is at least one selected from the group consisting of Al, Mg, Co, Fe, Ni, and Zn), lithium titanate (oxide containing Li and Ti), and lithium metal phosphate (LiMPO₄, M is at least one selected from the group consisting of Fe, Mn, Co, and Ni).

The positive electrode active material layers 112 may optionally contain a solid electrolyte for higher lithium ion conductivity. The positive electrode active material layers 112 may optionally contain a conductive agent for higher conductivity. The positive electrode active material layers 112 may optionally contain a binder for flexibility. The solid electrolyte, the conductive agent, and the binder may be of any kind, and those used for the positive electrode layers of general all-solid-state batteries can be used.

Each negative electrode layer 12 includes a negative electrode current collector 121 and a negative electrode active material layer 122 stacked on a surface of the negative electrode current collector 121 facing the solid electrolyte layer 13. The negative electrode current collector 121 is connected to the negative electrode tab 42.

The negative electrode current collector 121 may have any shape and may be made of any material as long as it exhibits the current collecting function of the negative electrode layer 12. Examples of materials for the negative electrode current collector 121 include nickel, copper, and stainless steel. The negative electrode current collector 121 may be in the shape of, for example, foil, a plate, mesh, nonwoven fabric, or a foam.

The negative electrode active material layer 122 may be made of any material that can be used as a negative electrode active material of a solid-state battery. The negative electrode active material layer 122 preferably contains lithium metal as the negative electrode active material. The lithium metal may be lithium metal alone or, for example, an alloy of lithium and Mg, Si, Au, Ag, In, Ge, Sn, Pb, Al, or Zn. The negative electrode active material layer 122 may be first formed as a layer of metal that can be alloyed with lithium, and then at least its surface may be alloyed with lithium. Other materials usable as the negative electrode active material layer 122 include Si, silicon-based active materials such as Si alloys, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metal indium.

The negative electrode active material layer 122 may also contain, for example, a solid electrolyte, a conductive agent, and a binder. The solid electrolyte may be the one similar to a solid electrolyte contained in the solid electrolyte layer 13 which will be described later. Examples of the conductive agent include carbon black, natural graphite, carbon fibers, and carbon nanotubes. Examples of the binders include nitrile polymers, polyester polymers, acrylic acid polymers, cellulose polymers, styrene polymers, styrene butadiene polymers, vinyl acetate polymers, urethane polymers, and fluoroethylene polymers.

The solid electrolyte layer 13 is arranged between the positive electrode active material layer 112 and the negative electrode current collector 121. The solid electrolyte layer 13 can include a first solid electrolyte layer 131 stacked on the positive electrode active material layer 112 and a second solid electrolyte layer 132 stacked on the negative electrode active material layer 122. The first solid electrolyte layer 131 can be pressure-bonded to the positive electrode layer 11, and the second solid electrolyte layer 132 can be pressure-bonded to the negative electrode layer 12. The first solid electrolyte layer 131 preferably has a larger outer peripheral portion than the positive electrode layer 11 in plan view.

The first solid electrolyte layer 131 can be a base-including body including a porous base and a first solid electrolyte composition filling pores of the porous base. The second solid electrolyte layer 132 can be a non-base body including a second solid electrolyte composition containing the solid electrolyte without any base. The porous base included in the first solid electrolyte layer 131 may be, for example, nonwoven fabric or woven fabric. Pressure-bonding the first solid electrolyte layer 131 and the second solid electrolyte layer 132 presses the second solid electrolyte layer 132 against pinholes formed in the first solid electrolyte layer 131, filling the pinholes with the second solid electrolyte composition.

The thickness of the first solid electrolyte layer 131 of the solid electrolyte layer 13 may be the same as or different from the thickness of the second solid electrolyte layer 132. The second solid electrolyte layer 132 may be thicker than the first solid electrolyte layer 131, for example.

The first solid electrolyte composition of the first solid electrolyte layer 131 and the second solid electrolyte composition of the second solid electrolyte layer 132 may contain the solid electrolyte and the binder. The first and second solid electrolyte compositions may contain the same solid electrolyte or different solid electrolytes. The first solid electrolyte composition may contain two or more solid electrolytes having different mean particle diameters. For example, the first solid electrolyte composition may contain a fine solid electrolyte having a mean particle diameter in a range of 0.1 μm or more to less than 0.5 μm and a coarse solid electrolyte having a mean particle diameter in a range of 1.0 μm or more to 10.0 μm or less. The fine solid electrolyte and the coarse solid electrolyte may be contained in a ratio of 1:9 to 9:1 by mass. The fine solid electrolyte improves the bonding between the first solid electrolyte layer 131 and the positive electrode layer 11. The coarse solid electrolyte improves filling properties of the solid electrolyte composition in the first solid electrolyte layer 131. The solid electrolyte in the second solid electrolyte composition may have a mean particle diameter in a range of, for example, 1.0 μm or more to 10.0 μm or less. The solid electrolyte in the first solid electrolyte composition may have a smaller mean particle diameter than the solid electrolyte in the second solid electrolyte composition. The mean particle diameter is a value measured by a laser diffraction method.

Any solid electrolyte can be contained in the first and second solid electrolyte compositions as long as it conducts lithium ions. For example, solid sulfide electrolytes, solid oxide electrolytes, solid nitride electrolytes, and solid halide electrolytes are usable.

Examples of the solid sulfide electrolytes include Li₂S-P₂S₅ and Li₂S-P₂S₅-LiI. The solid sulfide electrolytes may have an argyrodite-type crystal structure.

Examples of the solid oxide electrolytes include NASICON oxides, garnet oxides, and perovskite oxides. Examples of the NASICON oxides include oxides containing Li, Al, Ti, P, and O (e. g., Li_{1.5}Al_{0.5}Ti_{1.5} (PO₄)₃). Examples of the garnet oxides include oxides containing Li, La, Zr, and 0 (e.g., Li₇La₃Zr₂O₁₂). Examples of the perovskite oxides include oxides containing Li, La, Ti, and O (e.g., LiLaTiO₃).

The first and second solid electrolyte compositions may contain the same binder or different binders. Any binder may be used, and those used for the solid electrolyte layers of general all-solid-state batteries are usable. The content of the binder in the first solid electrolyte composition may be set in view of, for example, tight contact between the first solid electrolyte composition and the porous base and the strength and ion conductivity of the first solid electrolyte layer 131 as a whole. The content of the binder in the second solid electrolyte composition may be set in view of, for example, tight contact between the first and second solid electrolyte layers 131 and 132 and the ion conductivity of the second solid electrolyte layer 132 as a whole. The first solid electrolyte composition may contain more of the binder than the second solid electrolyte composition. The binder content of the first solid electrolyte composition may be in a range of, for example, 1.5 times or more to 10 times or less the binder content of the second solid electrolyte composition.

The elastic sheets 20 distribute a force exerted on the electrode laminates 10 in a planer direction when the all-solid-state battery 1 is pressurized in the thickness direction, reducing a local pressure overload on the electrode laminates 10. The elastic sheets 20 may be arranged only between some adjacent pairs of the electrode laminates 10. Suppose the number of the electrode laminates 10 is N, the number of the elastic sheets 20 is one or more and (N−2) or less, preferably two or more and less than half the number of the electrode laminates 10 (N/2). Reducing the elastic sheets 20 can keep the all-solid-state battery 1 from becoming thick.

Each elastic sheet 20 has a Young's modulus of 30 MPa or less, preferably 1 MPa or more and 30 MPa or less, more preferably 15 MPa or more and 20 MPa or less. The elastic sheets 20 having the Young's modulus within the certain range suitably distribute the force that binds the all-solid-state battery 1 in the thickness direction, suitably equalizing the pressure exerted on the electrode laminates 10. The Young's modulus of the elastic sheet 20 is measured in accordance with JIS-K7127 (1999).

Each elastic sheet 20 preferably has a thickness of 15 μm or more and 200 μm or less, more preferably 20 μm or more and 100 μm or less. The elastic sheets 20 having the thickness within the certain range can suitably distribute the pressure and reduce unwanted thickening of the electrode laminates 10.

The elastic sheet 20 may be made of a resin, for example, polyethylene or polypropylene. As a specific example, a soft polyethylene film having a specific gravity of 0.91 g/cm³ to 0.90 g/cm³ can be used as the elastic sheet 20. For a suitable Young's modulus, the elastic sheet 20 may be made of a porous material having fine pores. As a specific example, a porous resin sheet generally used as a separator of a secondary battery can be used as the elastic sheet 20.

The exterior body 30 may be made of, for example, a laminate film. Examples of the laminate film include a three-layer laminate film including an inner resin layer, a metal layer, and an outer resin layer stacked in this order from the inside to the outside. For example, the outer resin layer may be a polyamide (nylon) layer or a polyethylene terephthalate (PET) layer, the metal layer may be an aluminum layer, and the inner resin layer may be a polyethylene layer or a polypropylene layer.

The material of the positive electrode tab 41 may be the same as or different from the material of the positive electrode current collector 111. The positive electrode tab 41 may be formed integrally with the positive electrode current collector 111. In the present embodiment, the positive electrode tab 41 is a stack of strip-shaped extensions of the positive electrode current collectors 111 of the electrode laminates 10.

The material of the negative electrode tab 42 may be the same as or different from the material of the negative electrode current collector 121. The negative electrode tab 42 is a stack of strip-shaped extensions of the negative electrode current collectors 121 of the electrode laminates 10.

### Battery Module

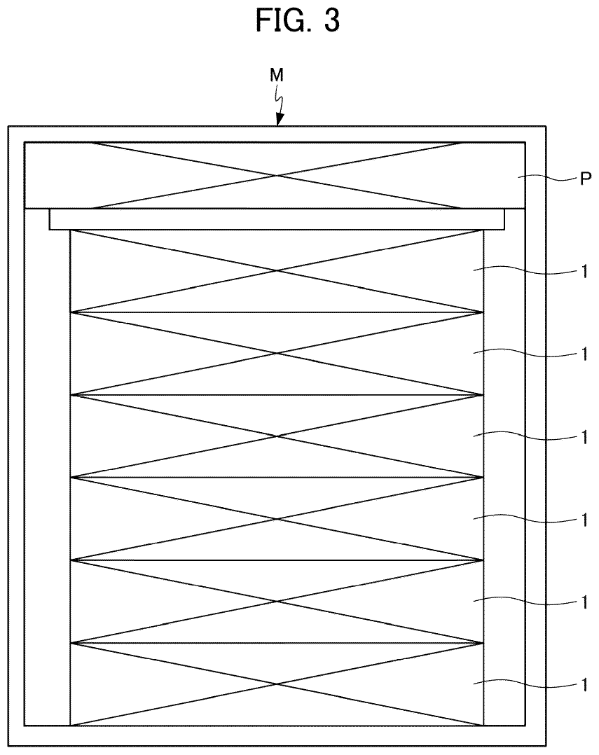

FIG. 3 is a schematic plan view illustrating the structure of a battery module M according to an embodiment of the present invention including the all-solid-state batteries 1. The battery module M includes a plurality of all-solid-state batteries 1 stacked in the thickness direction and a pressurizing mechanism P that pressurizes the all-solid-state batteries 1 in the thickness direction.

The pressurizing mechanism P applies a pressure binding the all-solid-state batteries 1 in the thickness direction to limit the expansion of the all-solid-state batteries 1 and reduce performance deterioration due to the expansion of the all-solid-state batteries 1. The pressurizing mechanism P may be any type of mechanism as long as it can suitably pressurize the all-solid-state batteries 1. For example, the pressurizing mechanism P may pressurize the all-solid-state batteries 1 using an elastic body such as a spring or foamed rubber or with a screw.

The pressurizing mechanism P applies a binding pressure of 3.0 MPa or less, preferably 0.1 MPa or more and 3.0 MPa or less, more preferably 0.5 MPa or more and 2.0 MPa or less. The binding pressure applied by the pressurizing mechanism P within the range suitably reduces the performance deterioration due to the expansion of the all-solid-state batteries 1. The binding pressure is a value obtained by dividing a force applied to the all-solid-state batteries by an area of the negative electrode.

Embodiments of the present invention have just been described above, but the present invention is not limited to the exemplary embodiments.

### EXAMPLES

The present invention will be described below in further detail by way of examples. The present invention is not limited to the examples.

As described in the embodiment, five electrode laminates each including a single positive electrode layer sandwiched between two pairs of a solid electrolyte layer and a negative electrode layer were stacked, with an elastic sheet sandwiched between the first and second electrode laminates and another elastic sheet sandwiched between the third and fourth electrode laminates. Thus, the all-solid-state batteries were prototyped. As the elastic sheets, soft polyethylene sheets having a thickness of 70 μm, a Young's modulus of 18.5 MPa, and a specific gravity of 0.91 g/cm³ to 0.92 g/cm³ or separators for a lithium ion battery having a thickness of 20 μm and a Young's modulus of 29.4 MPa were used. The all-solid-state batteries were prototyped with zero elastic sheets, two elastic sheets, and twelve (or eight) elastic sheets.

To the all-solid-state batteries, binding pressures of 1.0 MPa and 3.0 MPa were applied to measure variations in pressure exerted on the upper (outer) negative electrode of the first electrode laminate and the upper negative electrode of the third electrode laminate. For the measurement of the variations in pressure, 12×44 grids were set on the negative electrode, pressures exerted on the grids were measured, and a standard deviation calculated as a value indicating the variations in pressure was normalized as a percentage relative to the binding pressure.

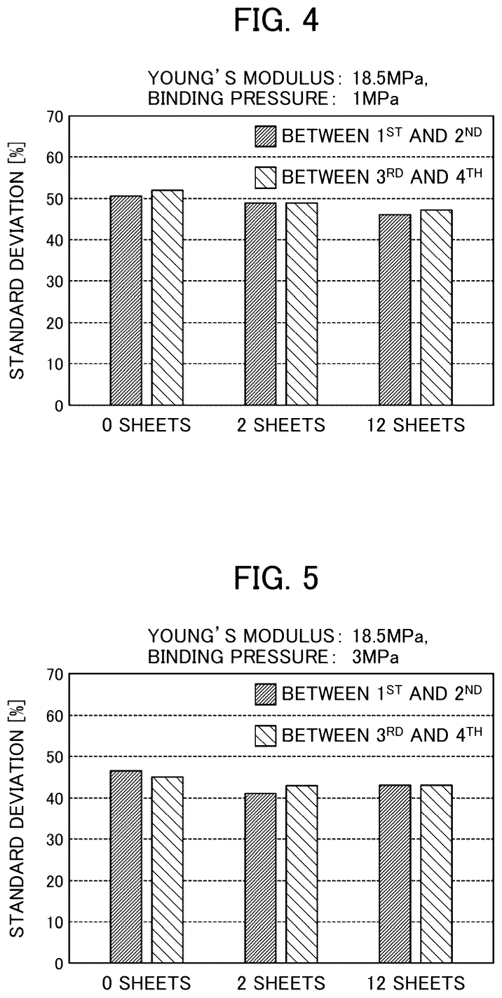

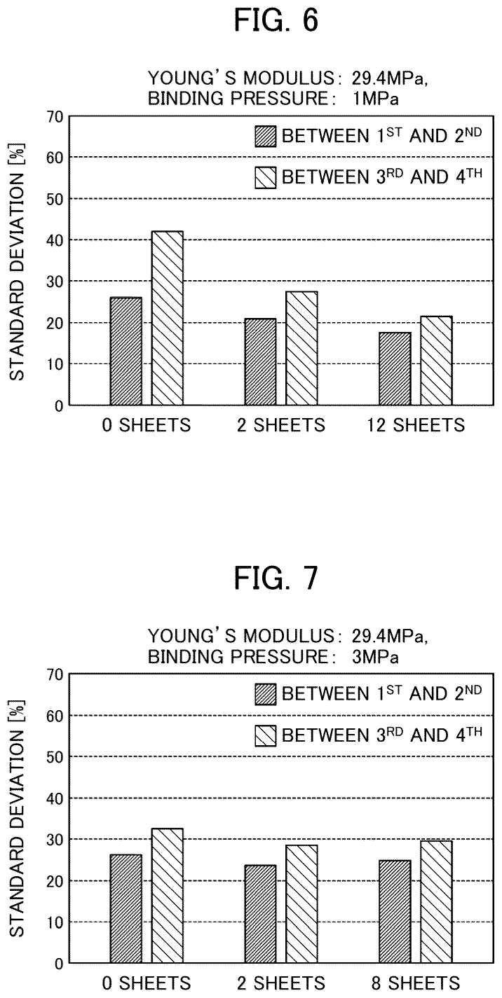

FIG. 4 shows the variations in pressure measured when the elastic sheets having a Young's modulus of 18.5 MPa were used and the binding pressure was 1.0 MPa. FIG. 5 shows the variations in pressure measured when the elastic sheets having a Young's modulus of 18.5 MPa were used and the binding pressure was 3.0 MPa. FIG. 6 shows the variations in pressure measured when the elastic sheets having a Young's modulus of 29.4 MPa were used and the binding pressure was 1.0 MPa. FIG. 7 shows the variations in pressure measured when the elastic sheets having a Young's modulus of 29.4 MPa were used and the binding pressure was 3.0 MPa.

In either case, the pressure variations were smaller when two elastic sheets were used than when zero elastic sheets were used. It was confirmed that the pressure variations with twelve elastic sheets were almost the same as the pressure variations with two elastic sheets.

### EXPLANATION OF REFERENCE NUMERALS

1 All-solid-state battery
10 Electrode laminate
11 Positive electrode layer
111 Positive electrode current collector
112 Positive electrode active material layer
12 Negative electrode layer
121 Negative electrode current collector
122 Negative electrode active material layer
13 Solid electrolyte layer
131 First solid electrolyte layer
132 Second solid electrolyte layer
20 Elastic sheet
30 Exterior body
41 Positive electrode tab
42 Tab
M Battery module
P Pressurizing mechanism

What is claimed is:

1. An all-solid-state battery, comprising:
a plurality of electrode laminates each including a positive electrode layer, a negative electrode layer, and a solid electrolyte layer arranged between the positive electrode layer and the negative electrode layer; and at least one elastic sheet arranged between the electrode laminates, wherein
some of the electrode laminates are in direct contact with adjacent one of the electrode laminates, and
the at least one elastic sheet has a Young's modulus of 30 MPa or less.

2. The all-solid-state battery according to claim 1, wherein the number of the at least one elastic sheet is two or more and less than half the number of the electrode laminates.

3. The all-solid-state battery according to claim 1, wherein the at least one elastic sheet has a Young's modulus of 15 MPa or more and 20 MPa or less.

4. A battery module, comprising:
a plurality of the all-solid-state batteries according to claim 1; and a pressurizing mechanism that applies a pressure binding the all-solid-state batteries in a thickness direction, wherein
the pressurizing mechanism applies a binding pressure of 3.0 MPa or less.

5. The battery module according to claim 4, wherein the binding pressure applied by the pressurizing mechanism is 0.5 MPa or more and 2.0 MPa or less.
